(19) United States
(12) Patent Application Publication
(10) Pub. No.: US 2024/0386593 A1
(43) Pub. Date: Nov. 21, 2024

(54) APPARATUS FOR DETERMINING A HEIGHT OF AN OBJECT OUTSIDE A VEHICLE AND A METHOD FOR THE SAME

(71) Applicants: HYUNDAI MOTOR COMPANY, Seoul (KR); KIA CORPORATION, Seoul (KR)

(72) Inventors: Ra Hoon Kang, Seoul (KR); Min Sung Son, Gwacheon-si (KR); Dong Yeoup Jeon, Seoul (KR); Ha Yong Woo, Gwangmyeong-si (KR); Seul Gi Kim, Seoul (KR)

(73) Assignees: HYUNDAI MOTOR COMPANY, Seoul (KR); KIA CORPORATION, Seoul (KR)

(21) Appl. No.: 18/505,816

(22) Filed: Nov. 9, 2023

(30) Foreign Application Priority Data
May 15, 2023 (KR) 10-2023-0062646

(51) Int. Cl. G06T 7/60; B60W 30/09; B60W 60/00; G06T 7/80; G06V 20/58

(52) U.S. Cl. CPC G06T 7/60; B60W 30/09; B60W 60/0015; G06T 7/80; G06V 20/58; B60W 2420/403; B60W 2554/80; G06T 2207/20081; G06T 2207/20084; G06T 2207/30261

(57) ABSTRACT

An apparatus for determining a height of an abject includes a camera to acquire a two-dimensional (2D) image and a processor. The processor detects a target object corresponding to an obstacle from the 2D image. The processor also determines a reference lower point from among pixels positioned at a lower portion of the target object. The processor further projects a preset reference line to the 2D image such that a reference point of the preset reference line is matched with the reference lower point. The processor additionally determines a height of the target object based on at least one threshold value for marking a preset distance, from the reference point, on the reference line.

### CROSS-REFERENCE TO RELATED APPLICATION

This application claims the benefit of and priority to Korean Patent Application No. 10-2023-0062646, filed in the Korean Intellectual Property Office on May 15, 2023, the entire contents of which are incorporated herein by reference.

### TECHNICAL FIELD

The present disclosure relates to an apparatus for determining a height of an object outside a vehicle and a method for the same, and more particularly to a technology of determining the height of an obstacle sensed outside a vehicle.

### BACKGROUND

An autonomous vehicle refers to a vehicle that self-drives without the handling by a driver or a passenger. An automated vehicle & highway system refers to a system that performs a monitoring operation and a control operation such that the autonomous vehicle self-drives. In addition, there have been suggested technologies of monitoring the outer portion of the vehicle to assist the driving by a driver and of operating various driving assist units, based on the monitored external environment of the vehicle.

A vehicle having autonomous vehicle functionality or a driving assist unit may detect an object by monitoring the outside of the vehicle. The vehicle may then be controlled based on a scenario determined depending on the detected object. For example, when an obstacle positioned outside the vehicle is detected, it may be determined whether the obstacle is in a region through which the vehicle is able to drive.

To determine whether the vehicle is able to drive while passing through the obstacle, the height of the obstacle needs to be determined.

When light detection and ranging is used to determine the height of the obstacle, the price of the vehicle may be significantly increased.

The object may also be detected by performing deep learning for a two-dimensional (2D) image. However, the deep learning result for the 2D image may merely indicate the class of the object and may not include exact information on the object height. Deep learning may be performed in addition to the class classification to determine the height in the image. However, the result of the deep learning is typically not accurate.

### SUMMARY

The present disclosure has been made to solve the above-mentioned problems occurring in the prior art while advantages achieved by the prior art are maintained intact.

Aspects of the present disclosure provide an apparatus and a method for determining an object height capable of more exactly determining the height of the obstacle without high-priced equipment.

Other aspects of the present disclosure provide an apparatus and a method for determining an object height capable of more accurately determining the object height without additional deep learning except for classification.

The technical problems to be solved by the present disclosure are not limited to the aforementioned problems. Other technical problems not mentioned herein should be clearly understood from the following description by those having ordinary skill in the art to which the present disclosure pertains.

According to an embodiment of the present disclosure, an apparatus for determining a height of an object outside of a vehicle is provided. The apparatus may include a camera configured to acquire a two-dimensional (2D) image. The apparatus may also include a processor. The processor may be configured to detect a target object corresponding to an obstacle from the 2D image. The processor may also be configured to determine a reference lower point from among pixels positioned at a lower portion of the target object, project a reference line to the 2D image such that a reference point of the preset reference line is matched with the reference lower point. The reference line may be preset. The processor may additionally be configured to determine a height of the target object based on at least one threshold value for marking a preset distance, from the reference point, on the reference line.

According to an embodiment, the processor may detect a lateral surface of a cubic structure as the target object based on determining that a lateral side and an upper portion of the cubic structure are classified into mutually different classes.

According to an embodiment, the processor may classify the target object into groups having the same horizontal coordinates on image coordinates of the 2D image. The processor may determine the reference lower point by selecting at least one of lowest coordinates of each of the groups.

According to an embodiment, the processor may transform world coordinates of the reference line into the image coordinates through camera calibration. The reference line may be set in a vertical axis direction in a world coordinate system.

According to an embodiment, the processor may compare a distance from the reference point to a comparison point at which the reference line corresponds to upper-most coordinates of each group with the threshold value.

According to an embodiment, the processor may determine the height of the target object as a height for limiting movement of the vehicle when a vertical coordinate value of the comparison point is a vertical coordinate value of a first threshold value.

According to an embodiment, the processor may determine the target object as noise when the vertical coordinate value of the comparison point is equal to or less than a vertical coordinate value of a second threshold value or is equal to or greater than a vertical coordinate value of a third threshold value.

According to an embodiment, the processor may determine the height of the target object based on a representative value preset between a first height and a second height based on determining that the vertical coordinate value of the comparison point is between a first height value for indicating the first height and a second height value for indicating the second height.

According to an embodiment, the processor may determine the representative value as noise when a difference between the representative value and an average of representative values acquired based on a plurality of different reference lower points close to the reference lower point is equal to or greater than a threshold difference.

According to an embodiment, the apparatus may further include an autonomous driving controller configured to control driving of the vehicle based on the height of the target object determined by the processor.

According to another aspect of the present disclosure, a method for determining a height of an object outside of a vehicle is provided. The method may include detecting a target object corresponding to an obstacle from a 2D image. The method may also include determining a reference lower point from among pixels positioned at a lower portion of the target object. The method may additionally include projecting a reference line to the 2D image such that a reference point of the preset reference line is matched with the reference lower point. The reference line may be preset. The method may further include determining a height of the target object based on at least one threshold value for marking a preset distance, from the reference point, on the reference line.

According to an embodiment, detecting the target object may include classifying a lateral side and an upper portion of a cubic structure into mutually different classes, and recognizing the lateral side of the cubic structure as the target object.

According to an embodiment, determining the reference lower point may include classifying the target object into groups having the same horizontal coordinates on image coordinates of the 2D image and determining the reference lower point by selecting at least one of lowest coordinates of each of the groups.

According to an embodiment, projecting the 2D image onto the reference line may include transforming world coordinates of the reference line into the image coordinates through camera calibration. The reference line may be set in a vertical axis direction in a world coordinate system.

According to an embodiment, determining the height of the target object may include comparing a distance from the reference point to a comparison point at which the reference line corresponds to upper-most coordinates of each group with the threshold value.

According to an embodiment, determining the height of the target object may include determining the height of the target object as a height for limiting movement of the vehicle when a vertical coordinate value of the comparison point is a vertical coordinate value of a first threshold value.

According to an embodiment, determining the height of the target object may include determining the target object as noise when the vertical coordinate value of the comparison point is equal to or less than a vertical coordinate value of a second threshold value or is equal to or greater than a vertical coordinate value of a third threshold value.

According to an embodiment, determining the height of the target object may include determining the height of the target object based on a representative value preset between a first height and a second height based on determining that the vertical coordinate value of the comparison point is between a first height value for indicating the first height and a second height value for indicating the second height.

According to an embodiment, determining the height of the target object further may include determining the representative value as noise when a difference between the representative value and an average of representative values acquired based on a plurality of different reference lower points close to the reference lower point is equal to or greater than a threshold difference.

According to an embodiment, the method may further include controlling a driving control device of the vehicle based on the height of the target object.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a view illustrating a vehicle, according to an embodiment of the present disclosure;

FIG. 2 is a block diagram illustrating the configuration of an apparatus for determining an object height, according to an embodiment of the present disclosure;

FIG. 3 is a flowchart illustrating a method for determining an object height, according to an embodiment of the present disclosure;

FIG. 4 is a view illustrating a segmentation model, according to an embodiment of the present disclosure;

FIG. 5 is a view illustrating a class classified based on segmentation, according to an embodiment of the present disclosure;

FIG. 6 is a view illustrating an image coordinate system, according to an embodiment of the present disclosure;

FIG. 7 is a view illustrating a reference line, according to an embodiment of the present disclosure;

FIG. 8 is a view illustrating a method for determining a height of a target object based on a reference line, according to an embodiment of the present disclosure;

FIG. 9 is a view illustrating a method for interpolating the height of the target object, according to an embodiment of the present disclosure; and

FIG. 10 is a view illustrating a computing system, according to an embodiment of the present disclosure.

### DETAILED DESCRIPTION

Hereinafter, embodiments of the present disclosure are described in detail with reference to accompanying drawings. In the accompanying drawings, identical or equivalent components are designated by the identical numerals even where the components are displayed on different drawings. In addition, in the following description, a detailed description of well-known features or functions has been omitted where the gist of the present disclosure may have been obscured thereby.

In describing the components of the embodiment according to the present disclosure, terms such as first, second, “A”, “B”, “(a)”, “(b)”, and the like may be used. These terms are merely intended to distinguish one component from another component. The terms do not limit the nature, sequence or order of the constituent components. In addition, unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings consistent with the contextual meanings in the relevant field of art. Such terms should not to be interpreted as having ideal or excessively formal meanings unless clearly defined as having such in the present disclosure.

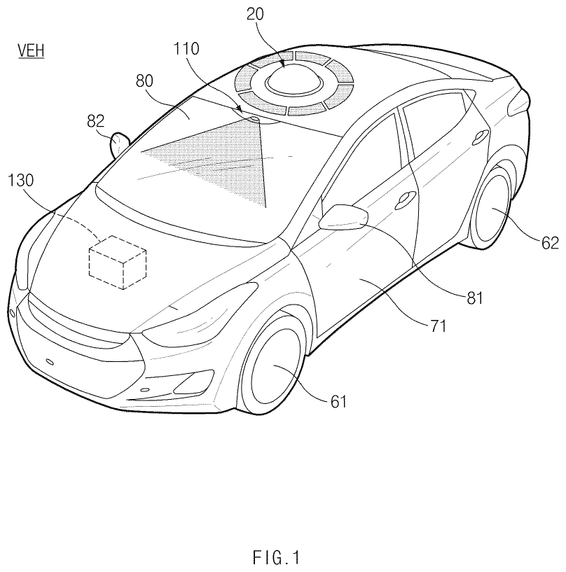

Hereinafter, embodiments of the present disclosure are be described with reference to FIGS. 1-10. When a component, device, element, or the like of the present disclosure is described as having a purpose or performing an operation, function, or the like, the component, device, or element should be considered herein as being “configured to” meet that purpose or perform that operation or function.

FIG. 1 is a view illustrating a vehicle, according to an embodiment of the present disclosure.

Referring to FIG. 1, according to an embodiment of the present disclosure, a vehicle VEH may include vehicle wheels 61 and 62, a door 71, a front glass 80, side-view mirrors 81 and 82, and a processor 130.

The vehicle wheels 61 and 62 may include the front wheel 61 provided in a front portion of the vehicle VEH and the rear wheel 62 provided in a rear portion of the vehicle. The front wheel 61 and the rear wheel 62 may be rotated by a driving device to move the vehicle VEH.

The door 71 may be provided rotatably at the left side or the right side of a main body of the vehicle VEH to allow an occupant to get into the vehicle VEH when the door 71 is open. When the door 71 is closed, the inner part of the vehicle VEH may be shielded from the outside.

The front glass 80 may be a type of wind glass. The front glass 80 may be provided at a front-upper portion of the main body of the vehicle VEH to provide, to a driver or a user inside the vehicle VEH, information on a visual field in front of the vehicle VEH.

The side-view mirrors 81 and 82 may include the left side-view mirror 81 provided at the left side of the main body of the vehicle VEH and the right side-view mirror 82 provided at the right side of the main body of the vehicle VEH. The side-view mirrors 81 and 82 may provide information on a visual field in rear of the vehicle VEH.

A camera 110 and a light imaging detection and ranging (LIDAR) 20 may be provided outside the vehicle VEH to acquire spatial information.

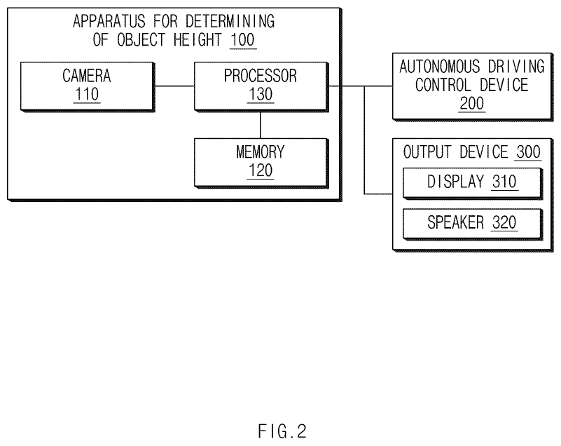

FIG. 2 is a block diagram illustrating an example configuration of an apparatus for determining a height of an object, according to an embodiment of the present disclosure.

Referring to FIG. 2, according to an embodiment of the present disclosure, the apparatus for determining a height of an object may include a camera 110, a memory 120, and a processor 130.

The camera 110 may acquire an external image of the vehicle. The camera 110 may be provided in the vicinity of a front wind shield of a vehicle and/or may be provided inside the vehicle, proximate to a front bumper or a radiator grill of the vehicle.

The memory 120 may store an algorithm and an artificial intelligence (AI) processor for the operation of the processor 130. The memory 120 may include a suitable combination of one or more of a non-volatile memory, such as a hard disk driver, a flash memory, an electrically erasable programmable read-only memory (EEPROM), a static RAM (SRMA), a ferro-electric RAM (FRAM), or a phase-change RAM (PRAM), a magnetic RAM (MRAM), a dynamic random access memory (DRAM), a synchronous dynamic random access memory (SDRAM), a double data rage-SDRAM (DDR-SDRAM), or the like.

The processor 130 may detect a target object corresponding to an obstacle from an external image acquired by the camera 110. The external image may be expressed on a 2D image plane. Pixels on the image plane may be expressed in the form of image coordinates. The processor 130 may detect the target object corresponding to the obstacle from the image using semantic segmentation. The pixels of the image may be assigned labels classified based on preset classes through the semantic segmentation. Accordingly, the target object may be expressed in the form of image coordinates. The obstacle may refer to a 3D object. According to an embodiment, the obstacle may refer to the lateral side of the 3D object.

In addition, the processor 130 may determine a reference lower point from among pixels positioned at a lower portion of the target object. The reference lower point may be selected from among lower-most coordinates of the pixels having the same horizontal coordinates. For example, the target object may include k horizontal coordinate components, where k is a natural number. In this example, k lower-most coordinates may be provided, and the reference lower point may be selected in the range of k or less.

The processor 130 may project a reference line onto the image, such that the reference point of the reference line is matched with the reference lower point. The reference line may be set in a vertical direction in a world coordinate system. The world coordinate system may be used to express an arbitrary point position in a real physical space. According to an embodiment of the present disclosure, an origin point of the world coordinate system may be a point at which a linear line orthogonal to a horizontal plane while passing through the center of a front bumper of the vehicle meets a horizontal plane. The x axis in the world coordinate system may be an axis for indicating the front direction of the vehicle. The y axis in the world coordinate system may be used as an axis for indicating the direction perpendicular to the reference axis on a plane parallel to the x axis. An xy plane may a plane parallel to the road surface. The z axis, which is an axis perpendicular to the xy plane, may be used as an axis for expressing the height from the road surface. Accordingly, the reference line may be a linear line formed in a z direction in the worked coordinate system.

The processor 130 may perform camera calibration to project the reference line to an image coordinate system.

In addition, the processor 130 may determine the height of the target object based on at least one threshold value on the reference line. The at least one threshold value may include one or more preset threshold values. The at least one threshold value may vary depending on the type of an obstacle. The at least one threshold value may include a first threshold value that may be used to determine whether the vehicle is movable. In addition, the at least one threshold value may include a second threshold value and a third threshold value that may be used to determine whether a pixel determined as the target object is noise. In addition, the at least one threshold value may include a plurality of height values. For example, the at least one threshold value may include a first height value for indicating a first height and a second height value for indicating a second height.

The processor 130 may perform AI learning for an external image received from the camera 110 to detect the object and to determine the height of the object. To this end, the processor 130 may include an artificial intelligence (AI) processor. The AI processor may train a neural network using a program that may be prestored. The neural network may be configured to detect a target vehicle and a dangerous vehicle. The neural network may be designed to simulate a brain structure of a human being over a computer. The neural network may include a plurality of network nodes having a weight for simulating a neuron of the neural network of the human being. The plurality of network nodes may transmit or receive data based on a connection relationship therebetween to simulate the synaptic activity of a neuron that allows the neuron to transmit or receive a signal through a synapse. The neural network may include a deep learning model developed from the neural network model. The plurality of network nodes in the deep learning model may be positioned in mutually different layers to transmit or receive data based on the convolution connection relation. The neural network model may include various deep learning schemes, such as deep neural networks (DNN), convolutional deep neural networks (CNN), recurrent Boltzmann machine (RNN), restricted Boltzmann machine (RBM), deep belief networks (DBN), a deep Q-network, or the like.

The processor 130 may control an autonomous driving control device 200 based on a scenario determined based on the height of the obstacle. For example, the processor 130 may control driving to avoid the obstacle when the obstacle having a specific level is present.

The processor 130 may control the autonomous driving control device 200 based on the height of the obstacle to determine the steering, the deceleration, or the acceleration of the vehicle.

The autonomous driving control device 200 may be configured to control the driving of the vehicle in response to a control signal from the processor 130. The autonomous driving control device 200 may include a steering control module, an engine control module, a braking control module, and a transmission control module. The autonomous driving control device 200 may be a device provided in a vehicle driving based on an autonomous driving level defined by the Korean Society Automotive Engineer, but the present disclosure is not so limited. For example, the autonomous driving control device 200 may be collectively referred to as a driving assist device enhancing the convenience of a user.

The steering control module may be a hydraulic power steering (HPS) system to control the steering using hydraulic pressure formed by a hydraulic pump or a motor driven power steering system (MDPS) to control the steering using output torque of an electrical motor.

The engine control module may serve as an actuator to control the engine of the vehicle. The engine control module may control the acceleration of the vehicle. The engine control module may be implemented using an engine management system (EMS). The engine control module may control driving torque of the engine based on information on a position of an acceleration pedal. The information on the position of the acceleration pedal may be obtained from an acceleration pedal position sensor. The engine control module may control the output of the engine to follow the driving speed of the vehicle received from the processor 130 in autonomous driving.

The braking control module may serve as an actuator to control the deceleration of the vehicle. The breaking control module may be implemented using electronic stability control (ESC). The braking control module may control braking pressure to follow the target speed required by the processor 130. Accordingly, the braking control module may control the deceleration of the vehicle.

The transmission control module may serve as an actuator to control the transmission of the vehicle. The transmission control module may be implemented using a shift by wire (SBW). The transmission control module may control the transmission of the vehicle based on the position of a gear and a gear state range.

An output device 300 may be configured to output information related to the height of the obstacle under the control of the processor 130. The output device 300 may include a display 310 and a speaker 320.

The processor 130 may visually express whether the vehicle is able to pass the determined height of the obstacle through the display 310.

In addition, the processor 130 may output an alarm sound through the speaker 320 when an obstacle making it difficult for the vehicle to pass approaches the vehicle.

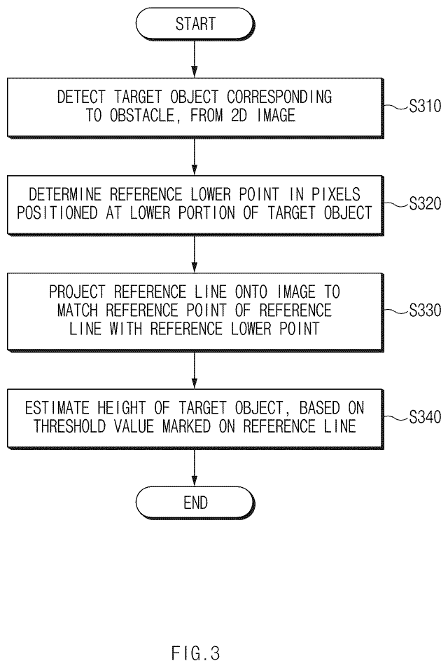

FIG. 3 is a flowchart illustrating a method for determining a height of an object, according to an embodiment of the present disclosure. FIG. 3 illustrates a procedure performed by the processor illustrated in FIG. 2, in an embodiment.

The following description is made with reference to FIG. 3 regarding the method for determining the height of the object.

In an operation S310, the processor 130 may detect a target object corresponding to the obstacle from an image of the external region of the vehicle.

The processor 130 may perform segmentation to detect the target object. A lateral side and an upper portion of a cubic structure may be classified into mutually different classes. The processor 130 may determine, as the obstacle, the class corresponding to the lateral side of the cubic structure.

In an operation S320, the processor 130 may determine a reference lower point from among pixels positioned at a lower portion of the target object.

The processor 130 may classify the target object into groups having the same horizontal coordinates of coordinates of the image. In addition, the processor 130 may determine the reference lower point by selecting at least one of lowest coordinates of the groups.

In an operation S330, the processor 130 may project the reference line onto the image such that the reference point of the reference line is matched with the reference lower point.

The processor 130 may set the reference line in the vertical direction in the world coordinate system. The processor 130 may project the reference line onto the image by transforming the coordinates of the reference line into image coordinates through the camera calibration.

In an operation S340, the processor 130 may determine the height of the target object based on a threshold value of the reference line.

The processor 130 may compare, with the threshold value, the distance between the reference point and a comparison point corresponding to the upper-most coordinates of each group.

The processor 130 may determine the target object as a structure limiting the movement of the vehicle when the vertical coordinate value of the comparison point is equal to or greater than the vertical coordinate value of the first threshold value.

In addition, the processor 130 may determine the target object as noise when the vertical coordinate value of the comparison point is equal to or less than a vertical coordinate value of a second threshold value or is equal to or greater than a vertical coordinate value of a third threshold value.

In addition, the processor 130 may determine the height of the target object based on a representative value preset between the first height and the second height based on determining that the vertical coordinate value of the comparison point is between a first height value for indicating the first height and a second height value for indicating the second height.

In addition, the processor 130 may determine the representative value as noise based on a difference between the representative value and an average of representative values that are obtained based on a plurality of different reference lower points close to the reference lower point.

Hereinafter, the details of procedures that may be performed by the processor 130, according to embodiments, are described.

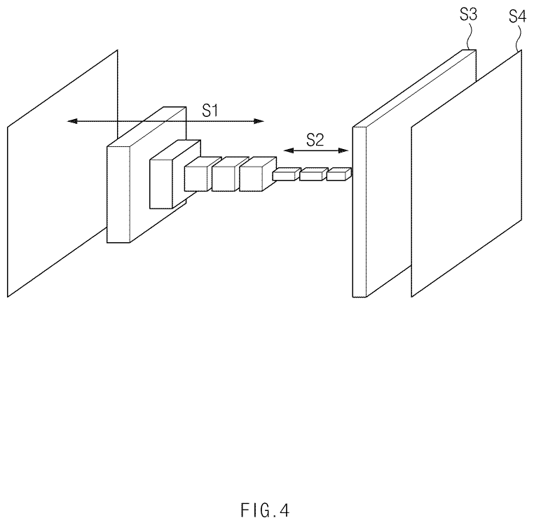

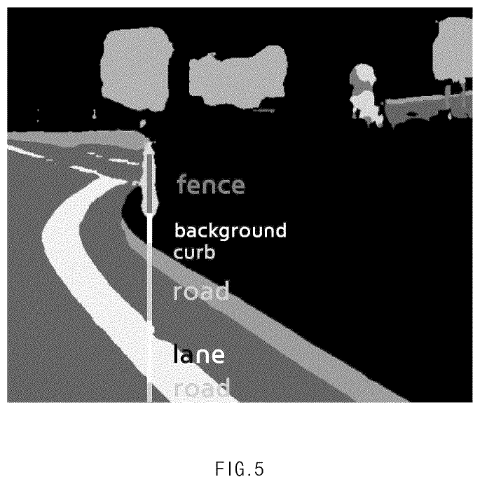

FIGS. 4 and 5 illustrate detection of an object corresponding to an obstacle based on an image, according to an embodiment. FIG. 4 is a view illustrating a segmentation model that may be used for segmentation of the image, according to an embodiment. The processor 130 may perform image training using a fully convolution network (FCN) model as illustrated in FIG. 4. The FCN, obtained by modifying a convolutional neural network (CNN)-based model showing excellent performance, may be for a semantic segmentation task.

The image classification may be performed by extracting features from all pixels in an image, inputting the extracted features into a classifier, and predicting a class of the input image. The typical model for image classification may incorporate a fully connected layer (FCL) into the last layer of a network. Since the input is required to have a constant size to use the FCL, the position information may be lost through the FCL. Accordingly, the FCL may not be suitable for the segmentation that may essentially require the position information.

The FCN may have the structure formed by substituting FCLs into convolution layers. Referring to FIG. 4, in an embodiment, the processor 130 may perform the following functions using the FCN.

In one or more operations S1, the processor 130 may extract a feature value from the external image through the convolution layer.

In one or more operations S2, the processor 130 may change the number of channels in a feature map to be equal to the number of data set objects by using a 1×1 convolution layer.

In one or more operations S3, the processor 130 may generate a map having the size equal to the size of the input image after performing up-sampling for a heat map having a lower resolution.

In one or more operations S4, the processor 130 may extract the feature map classified depending on classes.

Hereinafter, the obstacle and a method for labeling the obstacle based on the segmentation, according to an embodiment, is described.

FIG. 5 is a view illustrating a process of classifying the image based on the segmentation, according to an embodiment.

Referring to FIG. 5, the processor 130 may classify the image into classes of a road, a lane, a curb, a background, and a fence. The road curb may define the lateral side and may be detected as a target object.

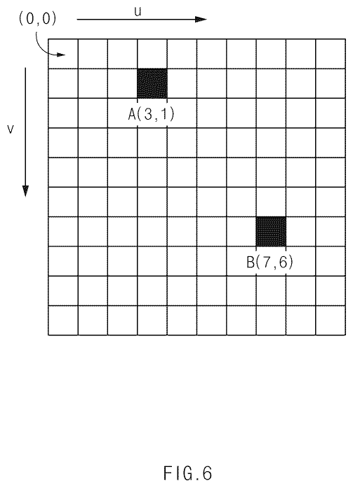

Each class may include position information of pixels. The target object may be expressed in the form of image coordinates. The image coordinates may be based on an image coordinate system illustrated in FIG. 6, for example.

FIG. 6 is a view illustrating an image coordinate system, according to an embodiment.

As illustrated in FIG. 6, the image coordinate system may be a coordinate system in which the left-uppermost pixel of the image is employed as an origin point (0,0), a horizontal position of the pixel may be expressed as a u-coordinate component, and a vertical position of the pixel may be expressed as a v-coordinate component. For example, a pixel A illustrated in FIG. 6 is expressed as (3,1), and a pixel B may be expressed as (7,6).

In an embodiment, the processor 130 perform a method for determining the reference lower point as follows.

The processor 130 may determine the reference lower point by selecting at least one of lowest coordinates of the target object. To this end, the processor 130 may classify the target object into groups having the same horizontal coordinates. In an example, m u-coordinate components of the target object, e.g., from an i-th u-coordinate component to an (i+(m−1)-th) u-coordinate component, are provided, where m is a natural number equal to or greater than 2. In this example, the target object may be classified into m groups. The processor 130 may determine points having the lowest coordinates in each group. The lowest coordinates may refer to image coordinates of a pixel having the greatest v-coordinate component.

The processor 130 may determine, as the reference lowest point, the lowest coordinates, of m lowest coordinates, selected at a specific distance.

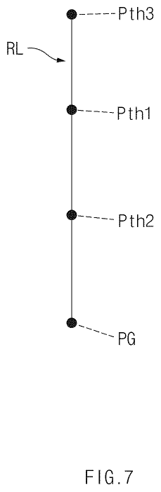

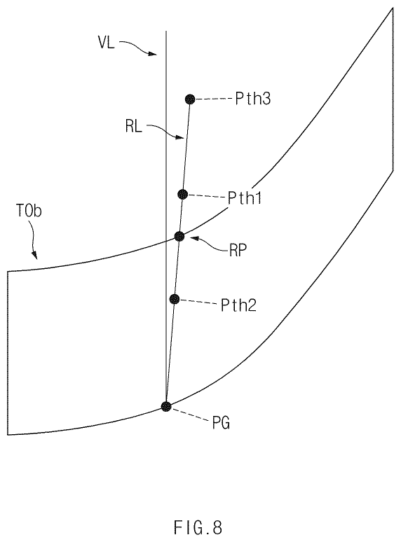

FIG. 7 is a view illustrating a reference line, according to an embodiment. FIG. 8 is a view illustrating a method for determining the height of a target object based on a reference line, according to an embodiment. Hereinafter, a method for determining the height of the target object using the reference line, according to an embodiment, is described with reference to FIGS. 7 and 8.

Referring to FIG. 7, a reference line RL may be preset to have the same direction as the vertical axis (z axis) in the world coordinate system.

A reference point PG may refer to the point having the smallest z-axis coordinates on the reference line RL.

A first threshold value Pth1, a second threshold value Pth2, and a third threshold value Pth3 may correspond to coordinates having a specific height from the reference point PG.

The distance between the reference point PG and the first threshold value Pth1, the second threshold value Pth2, and the third threshold value Pth3 may be set variously depending on the type of the target object or the type of the vehicle.

According to an embodiment, the first threshold value Pth1 provides a reference for determining whether the vehicle is able to pass the obstacle. For example, the first threshold value Pth1 may be set within 10 cm. The second threshold value Pth2 and the third threshold value Pth3 are used to determine whether the class classified as the target object. The second threshold value Pth2 may be set at a position closer to the reference point PG than the first threshold value Pth1. The third threshold value Pth3 may be set at a position farther away from the reference point PG than the first threshold value Pth1. The second threshold value Pth2 and the third threshold value Pth3 may be set based on the height of the obstacle.

As illustrated in FIG. 8, the processor 130 may project the reference line RL onto the image coordinates in the world coordinate system. The reference line RL, which is a vertical line in the world coordinate system, may not be expressed as the vertical line in the image coordinates due to distortion in the camera.

The processor 130 may transform the reference line RL expressed in the world coordinate system into the image coordinate system through camera calibration. The processor 130 may acquire the image coordinates of the reference line RL such that the coordinates of the reference point PG is matched with the reference lower point.

The processor 130 may determine, as a comparison point RP, a point in which the reference line meets the upper-most portion of the target object TOb in the image coordinates obtained by projecting the reference line RL. The comparison point RP may have coordinates belonging to a group different from a group to which the reference lower point belongs. For example, the same group as that of the reference lower point in the image coordinates may correspond to the u-coordinate component on the vertical axis VL passing the reference point PG, and the comparison point RP may be the u-coordinate component close to the vertical axis VL.

The processor 130 may determine the height of the target object TOb based on the position of the comparison point RP and the positions of the threshold values. For example, the processor 130 may determine the vehicle as passing the target object when the comparison point RP is closer to the reference point PG than the threshold value Pth1. In addition, the processor 130 may determine that the target object TOb restricts the driving of the vehicle when the comparison point RP is farther away from the reference point PG than the first threshold value Pth1.

The processor 130 may determine the target object as noise when the comparison point RP is closer to the reference point PG than the second threshold value Pth2. In addition, the processor 130 may determine the target object as noise when the comparison point RP is farther away from the reference point PG than the first threshold value Pth3.

The threshold values may also include height values for indicating the height. The processor 130 may determine the height of the target object as a representative value preset between a first height and a second height based on determining that the vertical coordinate value of the comparison point is between the first height value for indicating the first height and the second height value for indicating the second height. The representative height may be the average of the first height and the second height.

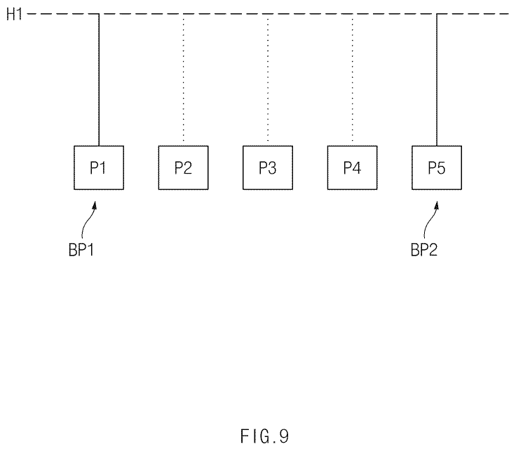

FIG. 9 is a view illustrating a process for interpolating the height of the target object, according to an embodiment.

Referring to FIG. 9, a first reference lower point BP1 and a second reference lower point BP2 may be selected from the lowest points adjacent to each other. The heights of the target object at the lowest points P2, P3, and P4, which are not selected as the reference lower points, may be interpolated based on the height determined at the first reference lower point BP1 and the height determined at the second reference lower point BP2. When the noise is removed, the processor 130 may determine the height of the target object as being constant. For example, the processor 130 may determine, as H1, the heights at the lowest points P2, P3, and P4 between the first reference lower points BP1 and the second reference lower point BP2 when the height at the first reference lower point BP1 and the height at the second reference lower point BP1 is H1. H1 may be information relatively indicating the position relationship between the comparison point and the threshold values. H1 may be the representative value between the first height value and the second height value.

In addition, in the process of determining the height of the comparison point RP, the processor 130 may determine the representative value as noise when the difference of the representative value from the average is equal to or greater than the threshold difference. For example, when the height of the target object determined at the first reference lower point BP is H1, the processor 130 may find H1_a by calculating the average of the heights of the target object determined at different reference lower points except for the first reference lower point BP1. When the difference between H1 and H1_a is equal to or greater than a preset threshold difference, the processor 130 may ignore the height H1 of the target object, which is determined at the first reference lower point BP1. The processor 130 may thus determine, as the average value H1_a, the height of the target object at the first reference lower point BP1.

As described above, the processor 130 may determine the height of the obstacle by comparing the reference line with the target objects detected as the obstacle, as the reference line generated in a 3D world coordinate system is projected to the 2D image.

According to embodiments of the present disclosure, the height of the obstacle may be accurately determined without high-priced equipment such as a Lidar.

According to embodiments of the present disclosure, the object height may be accurately determined by using only information on a class classified using image segmentation without performing additional deep learning to determine the height.

In embodiments, the processor 130 may control the autonomous driving control device 200 or the output device 300 based on the scenario determined based on the height of the obstacle.

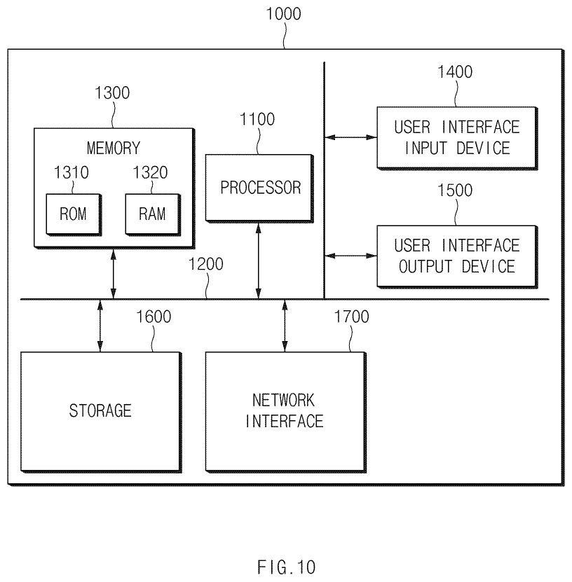

FIG. 10 illustrates a computing system, according to an embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the methods or algorithms described in connection with the embodiments disclosed in the present disclosure may be directly implemented with a hardware module, a software module, or the combinations thereof, executed by the processor 1100. The software module may reside on a storage medium (e.g., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The storage medium may be coupled to the processor 1100. Alternatively, the storage medium may be at least partially integrated with the processor 1100. The processor 1100 may read out information from the storage medium and may write information in the storage medium. The processor and storage medium may reside in an application specific integrated circuit (ASIC). The ASIC may reside in a user terminal. Alternatively, the processor and storage medium may be implemented with separate components in the user terminal.

As described above, according to embodiments of the present disclosure, because the height of an obstacle may be determined without high-priced equipment, the cost of parts of a vehicle may be reduced.

In addition, according to embodiments of the present disclosure, a height of an object may be more accurately determined without additional deep learning except for classification.

In addition, in various embodiments, a variety of effects directly or indirectly understood through the present disclosure may be provided.

The above description is merely an example of the technical idea of the present disclosure. Various modifications and alterations may be made by one having ordinary skill in the art without departing from the scope of the present disclosure.

Therefore, the embodiments of the present disclosure are provided to explain the spirit and scope of the present disclosure, but not to limit them. The spirit and scope of the present disclosure is not limited by the embodiments. The scope of the present disclosure should be construed on the basis of the accompanying claims, and all the technical ideas within the scope equivalent to the claims should be included in the scope of the present disclosure.

Hereinabove, although the present disclosure has been described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. An apparatus for determining a height of an object outside of a vehicle, the apparatus comprising:
a camera configured to acquire a two-dimensional (2D) image; and
a processor configured to
detect a target object corresponding to an obstacle from the 2D image,
determine a reference lower point from among pixels positioned at a lower portion of the target object,
project a reference line to the 2D image such that a reference point of the reference line is matched with the reference lower point, wherein the reference line is preset, and
determine a height of the target object based on at least one threshold value for marking a preset distance, from the reference point, on the reference line.

2. The apparatus of claim 1, wherein the processor is configured to:
detect a lateral surface of a cubic structure as the target object based on determining that a lateral side and an upper portion of the cubic structure are classified into mutually different classes.

3. The apparatus of claim 2, wherein the processor is configured to:
classify the target object into groups having same horizontal coordinates on image coordinates of the 2D image; and
determine the reference lower point by selecting at least one of lowest coordinates of each of the groups.

4. The apparatus of claim 3, wherein the processor is configured to:
transform world coordinates of the reference line into the image coordinates through camera calibration, wherein the reference line is set in a vertical axis direction in a world coordinate system.

5. The apparatus of claim 4, wherein the processor is configured to:
compare a distance from the reference point to a comparison point at which the reference line corresponds to upper-most coordinates of each group with the threshold value.

6. The apparatus of claim 5, wherein the processor is configured to:
determine the height of the target object as a height for limiting movement of the vehicle in response to determining that a vertical coordinate value of the comparison point is a vertical coordinate value of a first threshold value.

7. The apparatus of claim 6, wherein the processor is configured to:
determine the target object as noise in response to determining that the vertical coordinate value of the comparison point is equal to or less than a vertical coordinate value of a second threshold value or is equal to or greater than a vertical coordinate value of a third threshold value.

8. The apparatus of claim 5, wherein the processor is configured to:
determine the height of the target object based on a representative value preset between a first height and a second height based on determining that the vertical coordinate value of the comparison point is between a first height value for indicating the first height and a second height value for indicating the second height.

9. The apparatus of claim 8, wherein the processor is configured to:
determine the representative value as noise in response to determining that a difference between the representative value and an average of representative values acquired based on a plurality of different reference lower points close to the reference lower point is equal to or greater than a threshold difference.

10. The apparatus of claim 1, further comprising:
an autonomous driving controller configured to control driving of the vehicle based on the height of the target object determined by the processor.

11. A method for determining a height of an object outside of a vehicle, the method comprising:
detecting a target object corresponding to an obstacle from a 2D image;
determining a reference lower point from among pixels positioned at a lower portion of the target object;
projecting a reference line to the 2D image such that a reference point of the reference line is matched with the reference lower point, wherein the reference line is preset; and
determining a height of the target object, based on at least one threshold value for marking a preset distance, from the reference point, on the reference line.

12. The method of claim 11, wherein detecting the target object includes:
classifying a lateral side and an upper portion of a cubic structure into mutually different classes; and
recognizing the lateral side of the cubic structure as the target object.

13. The method of claim 12, wherein determining the reference lower point includes:
classifying the target object into groups having same horizontal coordinates on image coordinates of the 2D image; and
determining the reference lower point by selecting at least one of lowest coordinates of each of the groups.

14. The method of claim 13, wherein projecting the 2D image onto the reference line includes:
transforming world coordinates of the reference line into the image coordinates through camera calibration, wherein the reference line is set in a vertical axis direction in a world coordinate system.

15. The method of claim 14, wherein determining the height of the target object includes:
comparing a distance from the reference point to a comparison point at which the reference line corresponds to upper-most coordinates of each group with the threshold value.

16. The method of claim 15, wherein determining the height of the target object includes:
determining the height of the target object as a height for limiting movement of the vehicle in response to determining that a vertical coordinate value of the comparison point is a vertical coordinate value of a first threshold value.

17. The method of claim 16, wherein determining the height of the target object includes:
determining the target object as noise in response to determining that the vertical coordinate value of the comparison point is equal to or less than a vertical coordinate value of a second threshold value, or is equal to or greater than a vertical coordinate value of a third threshold value.

18. The method of claim 15, wherein determining the height of the target object includes:
determining the height of the target object based on a representative value preset between a first height and a second height based on determining that the vertical coordinate value of the comparison point is between a first height value for indicating the first height and a second height value for indicating the second height.

19. The method of claim 18, wherein determining the height of the target object further includes:
determining the representative value as noise in response to determining that a difference between the representative value and an average of representative values acquired based on a plurality of different reference lower points close to the reference lower point is equal to or greater than a threshold difference.

20. The method of claim 11, further comprising:
controlling a driving control device of the vehicle based on the height of the target object.
